(19) United States
(12) Patent Application Publication
(10) Pub. No.: US 2026/0302253 A1
(43) Pub. Date: Oct. 1, 2026

(54) NEGATIVE ELECTRODE AND SOLID-STATE LITHIUM ION SECONDARY BATTERY

(71) Applicant: HONDA MOTOR CO., LTD., Tokyo (JP)

(72) Inventors: Takafumi NAGAI, Saitama (JP); Masataka FURUYAMA, Saitama (JP); Wataru SHIMIZU, Saitama (JP); Wataru HOSHIKAWA, Saitama (JP); Narumi OHTA, Saitama (JP); Takamitsu ONUMA, Saitama (JP); Shodai KATO, Saitama (JP); Hiroshi SAKAI, Saitama (JP)

(21) Appl. No.: 19/575,938

(22) Filed: Mar. 24, 2026

(30) Foreign Application Priority Data
Mar. 31, 2025 (JP) 2025-059476
Dec. 19, 2025 (JP) 2025-268089

(51) Int. Cl. H01M 4/62; H01M 4/02; H01M 4/133; H01M 4/36; H01M 4/587; H01M 10/0525

(52) U.S. Cl. CPC H01M 4/628; H01M 4/133; H01M 4/366; H01M 4/587; H01M 4/623; H01M 10/0525; H01M 2004/027

(57) ABSTRACT

Provided is a negative electrode including a negative electrode mixture layer including a silicon-based active material and a first solid electrolyte, the silicon-based active material being coated with a coating layer including a second solid electrolyte and a binder. In an elemental mapping image with a 10000-fold magnification of a surface of the silicon-based active material, an arbitrary region of 0.20 μm square pertaining to the binder is defined as a starting point, the region closest to the arbitrary region is selected, and an average value of a distance between the arbitrary region and the closest region is 0.40 μm or more and 2.00 μm or less.

This application is based on and claims the benefit of priority from Japanese Patent Application Nos. 2025-059476 and 2025-268089, respectively filed on 31 Mar. 2025 and 19 Dec. 2025, the contents of which are incorporated herein by reference.

### BACKGROUND OF THE INVENTION

### Field of the Invention

The present invention relates to a negative electrode and a solid-state lithium ion secondary battery.

### Related Art

In recent years, research and development of all-solid-state lithium ion secondary batteries that contribute to energy efficiency has been carried out in order to ensure more people have access to affordable, reliable, sustainable, and advanced energy.

Japanese Unexamined Patent Application, Publication No. 2020-21674 describes an all-solid-state battery including a positive electrode layer, a negative electrode layer, and a solid electrolyte layer formed between the positive electrode layer and the negative electrode layer. Here, the negative electrode layer contains a silicon-based active material having an average particle diameter of less than 2.6 μm, and a first solid electrolyte. Furthermore, a coating layer containing a second solid electrolyte is formed on a surface of the silicon-based active material.
Patent Document 1: Japanese Unexamined Patent Application, Publication No. 2020-21674

### SUMMARY OF THE INVENTION

In the all-solid-state battery described in Japanese Unexamined Patent Application, Publication No. 2020-21674, when charging and discharging are repeated, according to expansion and contraction of the silicon-based active material, peeling is likely to occur at an interface between the first solid electrolyte and the second solid electrolyte included in the coating layer, and, as a result, a rate of increase in reaction resistance becomes high.

The present invention has an object to provide a negative electrode in which a rate of increase in reaction resistance is low even after charging and discharging are repeated.

(1) A negative electrode including a negative electrode mixture layer including a silicon-based active material and a first solid electrolyte, the silicon-based active material being coated with a coating layer including a second solid electrolyte and a binder. In an elemental mapping image with a 10000-fold magnification of a surface of the silicon-based active material, an arbitrary region of 0.20 μm square pertaining to the binder is defined as a starting point, the region closest to the arbitrary region is selected, and an average value of a distance between the arbitrary region and the closest region is 0.40 μm or more and 2.00 μm or less.

(2) The negative electrode described in (1), wherein the binder is fluorocarbon resin, and the elemental mapping image is a fluorine mapping image.

(3) The negative electrode described in (1) or (2), wherein the negative electrode mixture layer has a mass ratio of the binder to the silicon-based active material of 0.01 or more and less than 0.10.

(4) The negative electrode described in any one of (1) to (3), wherein the negative electrode mixture layer has a mass ratio of the second solid electrolyte to the silicon-based active material of 0.01 or more and 0.15 or less.

(5) The negative electrode described in any one of (1) to (4), wherein the second solid electrolyte is a sulfide solid electrolyte.

(6) The negative electrode described in (5), wherein the sulfide solid electrolyte is an argyrodite-type sulfide solid electrolyte.

(7) The negative electrode described in (5) or (6), wherein the first solid electrolyte is identical to the second solid electrolyte.

(8) The negative electrode described in any one of (1) to (7), wherein the coating layer has a thickness of 1 nm or more and 50 nm or less.

(9) The negative electrode described in (8), wherein the coating layer has a thickness of 2 nm or more and 10 nm or less.

(10) The negative electrode described in any one of (1) to (9), wherein the coating layer has a content of the binder of 10% by mass or more and 50% by mass or less.

(11) The negative electrode described in any one of (1) to (10), wherein the coating layer has a content of the second solid electrolyte of 50% by mass or more and 90% by mass or less.

(12) The negative electrode described in any one of (1) to (11), wherein the second solid electrolyte has a median diameter of 0.1 μm or more and 1.0 μm or less.

(13) The negative electrode described in any one of (1) to (12), wherein the negative electrode mixture layer has a content of the silicon-based active material of 50% by mass or more and 90% by mass or less.

(14) The negative electrode described in any one of (1) to (13), wherein the negative electrode mixture layer has a content of the first solid electrolyte of 10% by mass or more and 50% by mass or less.

(15) The negative electrode described in any one of (1) to (14), wherein the negative electrode mixture layer further includes a second binder.

(16) The negative electrode described in (15), wherein the negative electrode mixture layer has a content of the second binder of 1% by mass or more and 10% by mass or less.

(17) A solid-state lithium ion secondary battery including the negative electrode described in any one of (1) to (16).

(18) A method for manufacturing the negative electrode described in any one of (1) to (16), the method including mechanically milling the silicon-based active material and the second solid electrolyte to obtain a silicon-based active material coated with a coating layer including the second solid electrolyte; dry-mixing the silicon-based active material coated with the coating layer including the second solid electrolyte and the binder to obtain a silicon-based active material coated with a coating layer including the second solid electrolyte and the binder; and forming a negative electrode mixture layer by applying a slurry including the silicon-based active material coated with the coating layer including the second solid electrolyte and the binder and a first solid electrolyte.

The present invention can provide a negative electrode in which a rate of increase in reaction resistance is low even after charging and discharging are repeated.

### BRIEF DESCRIPTION OF THE DRAWINGS

FIG. 1 is a sectional view showing a part of a structure of a negative electrode mixture layer in accordance with an embodiment of the present invention; and

FIG. 2 is a sectional view showing a part of a structure of a negative electrode mixture layer in accordance with a comparative embodiment of the present invention.

### DETAILED DESCRIPTION OF THE INVENTION

Hereinafter, embodiments of the present invention are described with reference to drawings.

### Negative Electrode

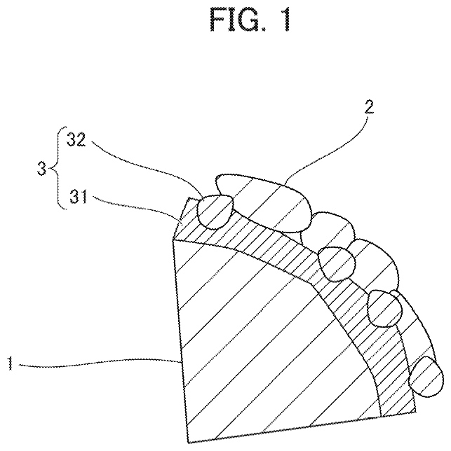

A negative electrode of this embodiment includes a negative electrode mixture layer including a silicon-based active material 1 and a first solid electrolyte 2 (see FIG. 1). The silicon-based active material 1 is coated with a coating layer 3 including a second solid electrolyte 31 and a binder 32. At this time, in an elemental mapping image with a 10000-fold magnification of a surface of the silicon-based active material 1, an arbitrary region (A₀) of 0.20 μm square pertaining to the binder 32 is defined as a starting point, a region (A₁) of 0.20 μm square pertaining to the binder 32 closest to the region (A₀) is selected, and an average value of a distance between the region (A₀) and the region (A₁) is 0.40 μm or more and 2.00 μm or less, preferably 0.42 μm or more and 1.50 μm or less, more preferably 0.46 μm or more and 1.30 μm or less, and further more preferably 0.46 μm or more and 0.60 μm or less. At this time, the distance between the region (A₀) and the region (A₁) is a distance between the center of the region (A₀) and the center of the region (A₁). Since the average value of the distances between the region (A₀) and the region (A₁) is 0.40 μm or more and 2.00 μm or less, even when charging and discharging are repeated and the silicon-based active material 1 is expanded and contracted, peeling is less likely to occur in the interface between the first solid electrolyte 2 and the second solid electrolyte 31 included in the coating layer 3. As a result, a rate of increase in the reaction resistance becomes low.

In the specification and claims, the region of 0.20 μm square pertaining to the binder 32 in the elemental mapping image with a 10000-fold magnification of the surface of the silicon-based active material 1 signifies a region selected so that the center of the binder 32 is the center of the region. At this time, the occupancy of the binder 32 in this region is 50% or more.

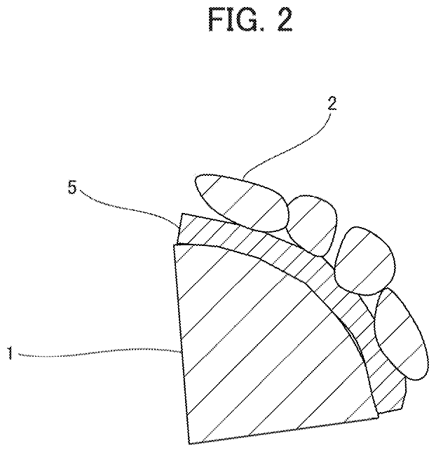

On the other hand, when the silicon-based active material 1 is coated with a coating layer 5, instead of the coating layer 3, including the second solid electrolyte 31 and not including the binder 32 (see FIG. 2), when charging and discharging are repeated and the silicon-based active material 1 is expanded and contracted, peeling is likely to occur in the interface between the first solid electrolyte 2 and the second solid electrolyte included in the coating layer 5. As a result, the rate of increase in the reaction resistance becomes high.

Note here that instead of the average value of the distance between the region (A₀) and the region (A₁), an average value of a distance between the region (A₁) and a region (A₁+1) that is closest to the region (A₁) may be used. In this case, an operation of selecting the closest region (A₁) from the region (A₀) as a starting point, an operation of selecting the closest region (A₂) from the region (A₁) as a starting point, . . . are repeated n times to select n regions (A₁ to Aₙ).

n is not particularly limited, and is, for example, an integer of 10 or more.

The binder 32 is not particularly limited, and examples include styrene-butadiene rubber, fluorocarbon resin, and polyimide. Among these, fluorocarbon resin is preferable because the binders 32 are easily scattered. When fluorocarbon resin is used as the binder 32, it is preferable to use a fluorine mapping image as the elemental mapping image.

The fluorocarbon resin is not particularly limited as long as fluorocarbon resin can bond the first solid electrolyte 2 to the second solid electrolyte 31 included in the coating layer 3, and examples of the fluorocarbon resin include polyvinylidene fluoride.

A melt viscosity of the binder 32 at 200° C. is preferably 20 kP or more and 80 kP or less, and further preferably 44 kP or more and 54 kP or less. When the melt viscosity of the binder 32 at 200° C. is 20 kP or more, the rate of increase in the reaction resistance is low even after charging and discharging are repeated, and when the melt viscosity is 80 kP or less, the initial reaction resistance becomes low.

The mass ratio of the binder 32 to silicon-based active material 1 in the negative electrode mixture layer is preferably 0.01 or more and less than 0.10, more preferably 0.02 or more and less than 0.07, and further preferably 0.03 or more and less than 0.05. When the mass ratio of the binder 32 to silicon-based active material 1 is 0.01 or more, the rate of increase in the reaction resistance is low even after charging and discharging are repeated, and when the mass ratio is less than 0.10, the initial reaction resistance becomes low.

The mass ratio of the second solid electrolyte 31 with respect to silicon-based active material 1 in the negative electrode mixture layer is 18 by mass or more and 15% by mass or less.

The content of the binder 32 in the coating layer 3 is preferably 10% by mass or more and 50% by mass or less, and further preferably 30% by mass or more and 408 by mass or less. When the content of the binder 32 in the coating layer 3 is 10% by mass or more, even after charging and discharging are repeated, the rate of increase in the reaction resistance is low, and when the content is 50% by mass or less, the initial reaction resistance becomes low.

The content of the second solid electrolyte 31 in the coating layer 3 is preferably 50% by mass or more and 90% by mass or less, and further preferably 608 by mass or more and 70% by mass or less. When the content of the second solid electrolyte 31 in the coating layer 3 is 50% by mass or more, the initial reaction resistance becomes low, and when the content is 90% by mass or less, the rate of increase in the reaction resistance is low even after charging and discharging are repeated.

A thickness of the coating layer 3 is preferably 1 nm or more and 50 nm or less, and further preferably 2 nm or more and 10 nm or less. When the thickness of the coating layer 3 is 1 nm or more, the initial reaction resistance becomes low, and when the thickness is 50 nm or less, the rate of increase in the reaction resistance is low even after charging and discharging are repeated.

The silicon-based active material 1 is not particularly limited, and examples thereof include a silicon simple substance, a silicon alloy, a silicon oxide, and a composite material including silicon and an element different from silicon. Examples of the silicon alloy include an SiC alloy, an SiN alloy, an SiTi alloy, an SiAl alloy, an SiLi alloy, and an SiCu alloy. Examples of the silicon oxide include SiO. Examples of the composite material including silicon and an element different from silicon include a composite material of silicon and lithium, a composite material of silicon and carbon, and a composite material of silicon and aluminum. The composite material including silicon and an element different from silicon may be a silicon alloy, or may not be a silicon alloy.

The silicon-based active material 1 is preferably a composite material including silicon and an element different from silicon. In the composite material including silicon and an element different from silicon, since the different material elements mitigate the influence due to expansion and contraction of silicon accompanying charging and discharging, the volume change of the silicon-based active material 1 due to expansion and contraction of silicon is mitigated. As a result, peeling is less likely to occur in an interface between the first solid electrolyte 2 and the second solid electrolyte 31 included in the coating layer 3, the rate of increase in the reaction resistance becomes lower even after charging and discharging are repeated.

The second solid electrolyte 31 is not particularly limited as long as the second solid electrolyte 31 can conduct lithium ions, and examples include an oxide solid electrolyte, and a sulfide solid electrolyte. Among these, a sulfide solid electrolyte is preferable from the viewpoint of initial reaction resistance, and an argyrodite-type sulfide solid electrolyte is particularly preferable.

The sulfide solid electrolyte includes, for example, a metal element (M) serving as a conducted ion and sulfur(S). Examples of M include Li, Na, K, Mg, and Ca. Among these, Li is preferable.

The sulfide solid electrolyte preferably includes Li, A that is one or more elements selected from the group consisting of P, Si, Ge, Al, and B, and S, and more preferably includes Li and P. The sulfide solid electrolyte may further include a halogen element (for example, Cl, Br, and I) from the viewpoint of ionic conductivity. The sulfide solid electrolyte may further include O.

Since the sulfide solid electrolyte has high ionic conductivity, even if some of a plurality of ion conduction paths are interrupted by repeated charging ad discharging, the ionic conductivity is maintained, and, as a result, the rate of increase in the reaction resistance becomes low.

Furthermore, since the sulfide solid electrolyte has high flexibility, even when the volume of the silicon-based active material 1 changes, interface peeling and cracking with respect to the first solid electrolyte 2 are less likely to occur. In other words, since the sulfide solid electrolyte follow the volume change of the silicon-based active material 1, along with the first solid electrolyte 2, interface peeling and cracking are less likely to occur.

Examples of the sulfide solid electrolyte include Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are positive numbers, and Z is Ge, Zn, or Ga.), Li₂S—GeS₂, Li₂S—SiS₂—Li₃PO₄, Li₂S—SiS₂—LiₓMO_{y} (wherein x and y are positive numbers, and M is P, Si, Ge, B, Al, Ga, or In.), LiᵥP_{w}SₓCl_{y}Br_{z} (V, W, x, y, z>0). Among these, LiᵥP_{w}SₓCl_{y}Br_{z} (v, w, x, y, z>0) is preferable because the reaction resistance is low even after charging and discharging are repeated, and LiᵥP_{w}SₓCl_{y}Br_{z} (0<v<10, 0<w<5, 0<x<5, 0<y<5, 0<z<5) is more preferable from the viewpoint of the ionic conductivity, and examples include Li_{5.4}PS_{4.4}Cl_{0.8}Br_{0.8}.

Note here that, for example, the description “Li₂S—P₂S” signifies a sulfide solid electrolyte using a raw material composition including Li₂S and P₂S₅, and the same is true to the other descriptions.

Furthermore, the sulfide solid electrolyte may be sulfide glass or crystallized sulfide glass, or may be a crystalline material obtained by a solid phase method. Note here that the sulfide glass is obtained, for example, by subjecting a raw material composition to a mechanical milling method (for example, a method of milling using a ball mill). Furthermore, the crystallized sulfide glass is obtained, for example, by heat-treating the sulfide glass at a temperature that is the crystallization temperature or higher.

The median diameter of the second solid electrolyte 31 is preferably 0.1 μm or more and 1.0 μm or less, and more preferably 0.2 μm or more and 0.7 μm or less. When the median diameter of the second solid electrolyte 31 is 0.1 μm or more and 1.0 μm or less, the initial reaction resistance becomes low.

The first solid electrolyte 2 is similar to the second solid electrolyte 31, but preferably identical to the second solid electrolyte 31. Thus, the initial reaction resistance becomes low.

The content of the silicon-based active material 1 in the negative electrode mixture layer is preferably 50% by mass or more and 90% by mass or less, and further preferably 65% by mass or more and 80% by mass or less. When the content of the silicon-based active material 1 in the negative electrode mixture layer is 50% by mass or more and 90% by mass or less, the initial reaction resistance becomes low.

The content of the first solid electrolyte 2 in the negative electrode mixture layer is preferably 10% by mass or more and 50% by mass or less, and further preferably 20% by mass or more and 30% by mass or less. When the content of the first solid electrolyte 2 in the negative electrode mixture layer is 10% by mass or more and 50% by mass or less, the initial reaction resistance becomes low.

It is preferable that the negative electrode mixture layer further includes a second binder. Thus, the rate of increase in the reaction resistance becomes low even after charging and discharging are repeated.

The content of the second binder in the negative electrode mixture layer is preferably 18 by mass or more and 10% by mass or less, and further preferably 1% by mass or more and 3% by mass or less. When the content of the second binder in the negative electrode mixture layer is 1% by mass or more, the rate of increase in the reaction resistance becomes low even after charging and discharging are repeated, and when the content is 10% by mass or less, the initial reaction resistance becomes low.

The second binder is similar to the binder 32, but preferably is identical to the binder 32. Thus, the rate of increase in the reaction resistance becomes low even after charging and discharging are repeated.

The negative electrode mixture layer may further include an electroconductive auxiliary agent.

The electroconductive auxiliary agent is not particularly limited, and examples thereof include carbon black such as acetylene black, Ketjen black, channel black, furnace black, lamp black, and thermal black, carbon such as carbon nanotubes and fullerenes, carbon fluorides, metals such as aluminum and nickel, and electroconductive polymers such as polyaniline, polythiophene, polyacetylene and polypyrrole.

A thickness of the negative electrode mixture layer is preferably, 0.1 μm or more and 1000 μm or less, more preferably 1 μm or more and 100 μm or less, and further preferably 10 μm or more and 30 μm or less.

The negative electrode of this embodiment includes, for example, a negative electrode mixture layer formed on a negative electrode current collector, and is applied to a solid-state lithium ion secondary battery.

The material constituting the negative electrode current collector is not particularly limited, and examples thereof include silver, palladium, gold, platinum, aluminum, copper, nickel, stainless steel, and carbon. Among these, copper, stainless steel, and nickel are preferable from the viewpoint of electroconductivity and cost.

The shape of the negative electrode current collector is not particularly limited, and examples thereof include a foil shape, a plate shape, a mesh shape, a nonwoven fabric shape, and a foamed shape.

A thickness of the negative electrode current collector is not particularly limited, and the thickness is, for example, 0.1 μm or more and 1 mm or less.

### Method for Manufacturing Negative Electrode

A method for manufacturing a negative electrode of this embodiment includes mechanically milling a silicon-based active material 1 and a second solid electrolyte 31 to obtain the silicon-based active material 1 coated with a coating layer including the second solid electrolyte 31. When the silicon-based active material 1 and the second solid electrolyte 31 are mechanically milled, for example, a ball mill is used. At this time, before the silicon-based active material 1 and the second solid electrolyte 31 are mechanically milled, the silicon-based active material 1 and the second solid electrolyte 31 may be preliminarily pulverized using, for example, a mortar.

The method for manufacturing a negative electrode of this embodiment further includes dry-mixing the silicon-based active material 1 coated with the coating layer including the second solid electrolyte 31 with the binder 32 to obtain the silicon-based active material 1 coated with the coating layer 3 including the second solid electrolyte 31 and the binder 32. Thus, the binders 32 can be scattered on the surface of the silicon-based active material 1 coated with the coating layer including the second solid electrolyte 31. In dry-mixing the silicon-based active material 1 coated with the coating layer including the second solid electrolyte 31 with the binder 32, for example, a rotation-revolution mixer is used.

The method for manufacturing the negative electrode of this embodiment further includes forming a negative electrode mixture layer by applying a slurry including the silicon-based active material 1 coated with the coating layer 3 including the second solid electrolyte 31 and the binder 32, and the first solid electrolyte.

The slurry may include a solvent having a boiling point of 120° C. or higher.

The solvent having a boiling point of 120° C. or higher is not particularly limited, and examples thereof include butyl butyrate (boiling point 166° C.), o-xylene (boiling point 144° C.), m-xylene (boiling point 139° C.), p-xylene (boiling point 138° C.), and decane (boiling point 174° C.).

### Solid-State Lithium Ion Secondary Battery

A solid-state lithium ion secondary battery of this embodiment includes a negative electrode of this embodiment, and further includes, for example, a positive electrode and an electrolyte. The solid-state lithium ion secondary battery is not particularly limited, and examples thereof include an all-solid-state lithium ion secondary battery including a solid electrolyte, and a semi-solid-state lithium ion secondary battery including a gel electrolyte. An all-solid-state lithium ion secondary battery will be described below.

### Solid Electrolyte Layer

A solid electrolyte constituting a solid electrolyte layer is not particularly limited, and examples of the solid electrolyte include sulfide solid electrolyte, and oxide solid electrolyte. Among these, from the viewpoint of the initial reaction resistance, the sulfide solid electrolyte is preferable, and an argyrodite-type sulfide solid electrolyte is particularly preferable.

Forms of the solid electrolyte are not particularly limited, and examples thereof include particles.

The content of the solid electrolyte in the solid electrolyte layer is not particularly limited, and the content is, for example, 50% by mass or more and 998 by mass or less.

The solid electrolyte layer may further include a binder and the like.

A method for forming a solid electrolyte layer is not particularly limited, and examples of the method includes a method of applying a slurry including a solid electrolyte.

A thickness of the solid electrolyte layer may be 0.1 μm or more and 1000 μm or less.

### Positive Electrode

In a positive electrode, for example, a positive electrode mixture layer is formed on a positive electrode current collector.

A positive electrode mixture layer includes a positive electrode active material. The positive electrode active material is not particularly limited, and examples thereof include lithium cobaltate (LiCoO₂), lithium nickelate (LiNiO₂), LiNiₚMn_{q}CoᵣO₂ (p+q+r=1), LiNiₚAl_{q}CoᵣO₂ (p+q+r=1), lithium manganate (LiMn₂O₄), Li₁₊ₓMn_{2-x-y}M_{y}O₄ (x+y=2) (wherein M is one or more elements selected from the group consisting of Al, Mg, Co, Fe, Ni, and Zn), lithium titanate, and LiMPO₄ (wherein M is one or more elements selected from the group consisting of Fe, Mn, Co, and Ni).

The content of the positive electrode active material in the positive electrode mixture layer may be 208 by mass or more, 40% by mass or more, and 50% by mass or more. On the other hand, the content of the positive electrode active material in the positive electrode mixture layer may be 99% by mass or less, 90% by mass or less, 80% by mass or less, and 60% by mass or less.

The positive electrode mixture layer may further include a solid electrolyte. The solid electrolyte is not particularly limited as long as the solid electrolyte is capable of conducting lithium ions, and examples thereof include an oxide solid electrolyte and a sulfide solid electrolyte. Among these, a sulfide solid electrolyte is preferable, and an argyrodite-type sulfide solid electrolyte is particularly preferable, from the viewpoint of the initial reaction resistance.

The positive electrode mixture layer may further include a binder, an electroconductive auxiliary agent, and the like.

A method for forming the positive electrode mixture layer is not particularly limited, and includes, for example, a method for applying a slurry including the positive electrode active material.

The material constituting the positive electrode current collector is not particularly limited, and examples thereof include aluminum, an aluminum alloy, stainless steel, nickel, iron, and titanium. Among these, aluminum, an aluminum alloy, and stainless steel are preferable.

The shape of the positive electrode current collector is not particularly limited, and examples thereof include a foil shape, and a plate shape.

The embodiments of the present invention have been described above, but the present invention is not limited to the embodiments described above, and the embodiments can be appropriately modified within a scope of the gist of the present invention.

### EXAMPLES

Hereinafter, Examples of the present invention are described, but the present invention is not limited to these Examples.

### Example 1

### Manufacture of Solid Electrolyte

Li₂S, P₂S₅, LiCl, and LiBr were weighed so as to satisfy the composition of Li_{5.4}PS_{4.4}Cl_{0.8}Br_{0.8}, and then mixed for 5 minutes using an agate mortar. After 2 g of the resulting mixture was put into a container of a planetary ball mill, dehydrated heptane and ZrO₂ balls were put, and the container was completely sealed. The container was attached to the planetary ball mill, and mechanical milling was carried out at a table rotation speed of 500 rpm for 20 hours. Thereafter, the mixture was dried at 110° C. for 1 hour to remove heptane and obtain a coarse-grained material.

The coarse-grained material was atomized. Specifically, the coarse-grained material was mixed with dehydrated heptane and dibutyl ether, so as to adjust that total amount was 10 g, and solid concentration was 10% by mass. The resulting mixture was put into the container of the planetary ball mill, then ZrO₂ balls were input therein, and the container was completely sealed. The container was attached to the planetary ball mill, and mechanical milling was carried out at a table rotation speed of 150 rpm. Thereafter, the mixture was dried to obtain an argyrodite-type sulfide solid electrolyte (Li_{5.4}PS_{4.4}Cl_{0.8}Br_{0.8}) having a median diameter (D₅₀) of 700 nm.

### Formation of Coating Layer

By using a mortar, 92 parts by mass of silicon/carbon composite material and 8 parts by mass of argyrodite-type sulfide solid electrolyte (Li_{5.4}PS_{4.4}Cl_{0.8}Br_{0.8}) having a median diameter (D₅₀) of 700 nm were dry-kneaded to obtain a preliminarily pulverized product. Then, the preliminarily pulverized product was mechanically milled using a planetary ball mill and 5-mm diameter zirconia balls to form a coating layer including a sulfide solid electrolyte on the surface of the silicon/carbon composite material.

By using a rotation-revolution mixer, 95 parts by mass of a silicon/carbon composite material coated with a sulfide solid electrolyte and 5 parts by mass of polyvinylidene fluoride (PVDF) having a melt viscosity of 50 kP at 200° C. were dry-mixed, and PVDF was scattered on the surface of the silicon/carbon composite material coated with the sulfide solid electrolyte to form a coating layer including the sulfide solid electrolyte and PVDF. At this time, a thickness of the coating layer was 0.01 μm.

By using a scanning electron microscopy-energy dispersive X-ray analyzer (SEM-EDX), a fluorine mapping image with a 10000-fold magnification of the surface of the silicon/carbon composite material coated with the coating layer including sulfide solid electrolyte and PVDF was acquired. When an operation of selecting the closest region of 0.2 μm square pertaining to PVDF starting from an arbitrary region of 0.2 μm square pertaining to PVDF in the fluorine mapping image was repeated 9 times to select 10 regions, and when the average value of the distance between the closest regions (the degree of scattering of PVDF) was calculated, the value was 0.45 μm. At this time, using an image analysis software ImageJ, a green region having a numerical range of contrast of 40 to 255 in the fluorine mapping image was made to pertain to PVDF.

### Manufacture of Negative Electrode

By using an ultrasonic homogenizer, 70 parts by mass of silicon/carbon composite material coated with a coating layer including a sulfide solid electrolyte and PVDF, 27 parts by mass of an argyrodite-type sulfide solid electrolyte (Li_{5.4}PS_{4.4}Cl_{0.8}Br_{0.8}) having a median diameter (D₅₀) of 700 nm, 2 parts by mass of polyvinylidene fluoride (PVDF), and 1 part by mass of electroconductive auxiliary agent acetylene black Li-100 (manufactured by Denka) were dispersed in butyl butyrate to obtain a slurry.

The slurry was applied to a copper foil and dried to form a negative electrode mixture layer, and then the mixture layer was punched into a size of 10 mm in diameter to obtain a negative electrode.

### Example 2

A negative electrode was obtained in a manner similar to Example 1 except that 97 parts by mass of silicon/carbon composite material coated with sulfide solid electrolyte and 3 parts by mass of PVDF were dry-mixed in “Formation of coating layer”. At this time, the coating layer had a thickness of 0.01 μm, and a scattering degree of PVDF of 0.48 μm.

### Example 3

A negative electrode was obtained in a manner similar to Example 1 except that 99 parts by mass of a silicon/carbon composite material coated with sulfide solid electrolyte and 1 part by mass of PVDF were dry-mixed in “Formation of coating layer”. At this time, the coating layer had a thickness of 0.01 μm, and a scattering degree of PVDF of 1.22 μm.

### Comparative Example 1

A negative electrode was obtained in a manner similar to Example 1 except that a silicon/carbon composite material coated with sulfide solid electrolyte and PVDF were not dry-mixed with each other in “Formation of coating layer”.

### Comparative Example 2

A negative electrode was obtained in a manner similar to Example 1 except that 90 parts by mass of a silicon/carbon composite material coated with sulfide solid electrolyte and 10 parts by mass of PVDF were dry-mixed in “Formation of coating layer”. At this time, the coating layer had a thickness of 0.01 μm, and a scattering degree of PVDF of 0.37 μm.

### Example 4

### Manufacture of Solid Electrolyte

An argyrodite-type sulfide solid electrolyte (Li_{5.4}PS_{4.4}Cl_{0.8}Br_{0.8}) having a median diameter (D₅₀) of 200 nm was obtained in a manner similar to Example 1 except that the time of mechanical milling was changed.

### Formation of Coating Layer

By using a mortar, 92 parts by mass of silicon/carbon composite material and 8 parts by mass of argyrodite-type sulfide solid electrolyte (Li_{5.4}PS_{4.4}Cl_{0.8}Br_{0.8}) having a median diameter (D₅₀) of 200 nm were dry-kneaded to obtain a preliminarily pulverized product. Then, the preliminarily pulverized product was mechanically milled using a planetary ball mill and 5-mm diameter zirconia balls to form a coating layer including a sulfide solid electrolyte on the surface of the silicon/carbon composite material.

By using a rotation-revolution mixer, 95 parts by mass of a silicon/carbon composite material coated with a sulfide solid electrolyte and 5 parts by mass of polyvinylidene fluoride (PVDF) having a melt viscosity of 50 kP at 200° C. were dry-mixed, and PVDF was scattered on the surface of the silicon/carbon composite material coated with the sulfide solid electrolyte to form a coating layer including the sulfide solid electrolyte and PVDF. At this time, a thickness of the coating layer was 0.01 μm.

By using a scanning electron microscopy-energy dispersive X-ray analyzer (SEM-EDX), a fluorine mapping image with a 10000-fold magnification of the surface of the silicon/carbon composite material coated with the coating layer including sulfide solid electrolyte and PVDF, was acquired. When an operation of selecting the closest region of 0.2 μm square pertaining to PVDF starting from an arbitrary region of 0.2 μm square pertaining to PVDF in the fluorine mapping image was repeated 9 times to select 10 regions, and when the average value of the distance between the closest regions (the degree of scattering of PVDF) was calculated, the value was 0.45 μm. At this time, using an image analysis software ImageJ, a green region having a numerical range of contrast of 40 to 255 in the fluorine mapping image was made to pertain to PVDF.

### Manufacture of Negative Electrode

By using an ultrasonic homogenizer, 67.5 parts by mass of silicon/carbon composite material coated with a coating layer including a sulfide solid electrolyte and PVDF, 30.5 parts by mass of an argyrodite-type sulfide solid electrolyte (Li_{5.4}PS_{4.4}Cl_{0.8}Br_{0.8}) having a median diameter (D₅₀) of 200 nm, 1 part by mass of polyvinylidene fluoride (PVDF), and 1 part by mass of an electroconductive auxiliary agent acetylene black Li-100 (manufactured by Denka) were dispersed in butyl butyrate to obtain a slurry.

The slurry was applied to a copper foil and dried to form a negative electrode mixture layer, and then the mixture layer was punched into a size of 10 mm in diameter to obtain a negative electrode.

### Example 5

A negative electrode was obtained in a manner similar to Example 4 except that 97 parts by mass of a silicon/carbon composite material coated with sulfide solid electrolyte and 3 parts by mass of PVDF were dry-mixed in “Formation of coating layer”. At this time, the coating layer had a thickness of 0.01 μm, and a scattering degree of PVDF of 0.48 μm.

### Example 6

A negative electrode was obtained in a manner similar to Example 4 except that 99 parts by mass of a silicon/carbon composite material coated with sulfide solid electrolyte and 1 part by mass of PVDF were dry-mixed in “Formation of coating layer”. At this time, the coating layer had a thickness of 0.01 μm, and a scattering degree of PVDF of 1.22 μm.

### Comparative Example 3

A negative electrode was obtained in a manner similar to Example 4 except that a silicon/carbon composite material coated with a sulfide solid electrolyte and PVDF were not dry-mixed with each other in “Formation of coating layer”.

### Comparative Example 4

A negative electrode was obtained in a manner similar to Example 4 except that 90 parts by mass of a silicon/carbon composite material coated with sulfide solid electrolyte and 10 parts by mass of PVDF were dry-mixed in “Formation of coating layer”. At this time, the coating layer had a thickness of 0.01 μm, and a scattering degree of PVDF of 0.37 μm.

### Manufacture of Half Cell

An argyrodite-type sulfide solid electrolyte (Li_{5.4}PS_{4.4}Cl_{0.8}Br_{0.8}) having a median diameter (D₅₀) of 700 nm was put into a 10-mm diameter zirconia cylindrical tube, sandwiched between SUS jigs, and pressed at 2 t/cm² to obtain a solid electrolyte layer. Next, the solid electrolyte layer and the negative electrode were laminated and pressed at 10 t/cm² to obtain a solid electrolyte layer-negative electrode laminated body. Next, a solid electrolyte layer-negative electrode laminated body was restrained at a restraining pressure of 3 MPa, and then left under a vacuum environment at 200° C. for two hours. Next, a lithium foil having a diameter of 10 mm was laminated on the side of the solid electrolyte layer of the solid electrolyte layer-negative electrode laminated body, and then was restrained at a restraining pressure of 3 MPa to obtain a half cell.

### Charging and Discharging Test

A charging and discharging test of a half cell was carried out. Specifically, charging and discharging were repeated three times at a constant current density of 0.1 C in a voltage range corresponding to SOC of 0% to 60% at 25° C. The AC impedance was measured after stopping the charging and discharging test at the first and third SOC of 60%, and the reaction resistance R₁ [Ω·cm²] at the SOC of 60% at the first charging and discharging and the reaction resistance R₃ [Ω·cm²] at the SOC of 60% at the third charging and discharging were measured. Then, the rate of increase in the reaction resistance R₃/R₁ was calculated.

### Dispersion State of PVDF in Negative Electrode

By using a scanning electron microscopy-energy dispersive X-ray analyzer (SEM-EDX), a fluorine mapping image with a 1000-fold magnification of the cross section of the negative electrode was acquired, and the dispersion state of PVDF was evaluated. Note here that the criteria for determining the dispersion state of PVDF are as follows. A: Case in which no region having a diameter of 3.5 μm or more is observed. B: Case in which a region having a diameter of 3.5 μm or more is observed.

Evaluation results of the half cell are shown in Tables 1 and 2.

TABLE 1

| | Degree of | Dispersion | | | |
|---|---|---|---|---|---|
| | scattering | state of | Reaction resistance | | |
| | of PVDF [μm] | PVDF | R₁ [Ωcm²] | R₃ [Ωcm²] | R₃/R₁ |
| Example 1 | 0.45 | A | 0.95 | 2.21 | 2.33 |
| Example 2 | 0.48 | A | — | — | — |
| Example 3 | 1.22 | A | — | — | — |
| Comparative | — | — | 0.50 | 2.39 | 4.78 |
| Example 1 | | | | | |
| Comparative | 0.37 | B | — | — | — |
| Example 2 | | | | | |

TABLE 2

| | Degree of | Dispersion | | | |
|---|---|---|---|---|---|
| | scattering | state of | Reaction resistance | | |
| | of PVDF [μm] | PVDF | R₁ [Ωcm²] | R₃ [Ωcm²] | R₃/R₁ |
| Example 4 | 0.45 | A | 22 | 57 | 2.55 |
| Example 5 | 0.48 | A | 17 | 29 | 1.73 |
| Example 6 | 1.22 | A | 21 | 43 | 2.09 |
| Comparative | — | — | 36 | 101 | 2.81 |
| Example 3 | | | | | |
| Comparative | 0.37 | B | 20 | 57 | 2.90 |
| Example 4 | | | | | |

Tables 1 and 2 show that when the negative electrodes of Examples 1, 4 to 6 are used, even after charging and discharging are repeated, the rate of increase in the reaction resistance becomes low. It is presumed that the rate of increase in the reaction resistance becomes low because the dispersion state of PVDF is good at the negative electrode. Furthermore, when the negative electrodes of Examples 2 and 3 are used, it is presumed that the rate of increase in the reaction resistance becomes low even after charging and discharging are repeated as in the case of using the negative electrode of Example 1 in which the dispersion state of PVDF is good.

On the contrary, in the negative electrodes of Comparative Examples 1 and 3, since the surface of the silicon/carbon composite material does not include PVDF, when charging and discharging are repeated, the rate of increase in the reaction resistance becomes high. Furthermore, in the negative electrode of Comparative Example 4, since the dispersion state of PVDF is poor, when charging and discharging are repeated, the rate of increase in the reaction resistance becomes high. Furthermore, in the negative electrode of Comparative Example 2, since the dispersion state of PVDF is poor, when charging and discharging are repeated, it is presumed that the rate of increase in the reaction resistance becomes high.

### EXPLANATION OF REFERENCE NUMERALS

1 Silicon-based active material
2 First solid electrolyte
3, 5 Coating layer
31 Second solid electrolyte
32 Binder

What is claimed is:

1. A negative electrode comprising:
a negative electrode mixture layer comprising a silicon-based active material and a first solid electrolyte,
the silicon-based active material being coated with a coating layer comprising a second solid electrolyte and a binder, wherein
in an elemental mapping image with a 10000-fold magnification of a surface of the silicon-based active material, an arbitrary region of 0.20 μm square pertaining to the binder is defined as a starting point, the region closest to the arbitrary region is selected, and an average value of a distance between the arbitrary region and the closest region is 0.40 μm or more and 2.00 μm or less.

2. The negative electrode according to claim 1, wherein
the binder is fluorocarbon resin, and
the elemental mapping image is a fluorine mapping image.

3. The negative electrode according to claim 1, wherein the negative electrode mixture layer has a mass ratio of the binder to the silicon-based active material of 0.01 or more and less than 0.10.

4. The negative electrode according to claim 1, wherein the negative electrode mixture layer has a mass ratio of the second solid electrolyte to the silicon-based active material of 0.01 or more and 0.15 or less.

5. The negative electrode according to claim 1, wherein the second solid electrolyte is a sulfide solid electrolyte.

6. The negative electrode according to claim 5, wherein the sulfide solid electrolyte is an argyrodite-type sulfide solid electrolyte.

7. The negative electrode according to claim 5, wherein the first solid electrolyte is identical to the second solid electrolyte.

8. The negative electrode according to claim 1, wherein the coating layer has a thickness of 1 nm or more and 50 nm or less.

9. The negative electrode according to claim 8, wherein the coating layer has a thickness of 2 nm or more and 10 nm or less.

10. The negative electrode according to claim 1, wherein the coating layer has a content of the binder of 10% by mass or more and 50% by mass or less.

11. The negative electrode according to claim 1, wherein the coating layer has a content of the second solid electrolyte of 50% by mass or more and 90% by mass or less.

12. The negative electrode according to claim 1, wherein the second solid electrolyte has a median diameter of 0.1 μm or more and 1.0 μm or less.

13. The negative electrode according to claim 1, wherein the negative electrode mixture layer has a content of the silicon-based active material of 50% by mass or more and 90% by mass or less.

14. The negative electrode according to claim 1, wherein the negative electrode mixture layer has a content of the first solid electrolyte of 10% by mass or more and 50% by mass or less.

15. The negative electrode according to claim 1, wherein the negative electrode mixture layer further comprises a second binder.

16. The negative electrode according to claim 15, wherein the negative electrode mixture layer has a content of the second binder of 1% by mass or more and 10% by mass or less.

17. A solid-state lithium ion secondary battery comprising the negative electrode according to claim 1.

18. A method for manufacturing the negative electrode according to claim 1, the method comprising:
mechanically milling the silicon-based active material and the second solid electrolyte to obtain a silicon-based active material coated with a coating layer comprising the second solid electrolyte;
dry mixing the silicon-based active material coated with the coating layer comprising the second solid electrolyte and the binder to obtain a silicon-based active material coated with a coating layer comprising the second solid electrolyte and the binder; and
forming a negative electrode mixture layer by applying a slurry comprising the silicon-based active material coated with the coating layer comprising the second solid electrolyte and the binder and a first solid electrolyte.
